(19) United States
(12) Patent Application Publication
(10) Pub. No.: US 2010/0209816 A1
(43) Pub. Date: Aug. 19, 2010

(54) FUEL ELECTRODE MATERIAL, METHOD OF PREPARING THE FUEL ELECTRODE MATERIAL, AND SOLID OXIDE FUEL CELL INCLUDING THE FUEL ELECTRODE MATERIAL

(75) Inventors: Chan KWAK, Yongin-si (KR); Sang-mock LEE, Yongin-si (KR); Hee-jung PARK, Yongin-si (KR)

Correspondence Address: CANTOR COLBURN, LLP, 20 Church Street, 22nd Floor, Hartford, CT, 06103, US

(73) Assignee: SAMSUNG ELECTRONICS CO., LTD., Suwon-si (KR)

(21) Appl. No.: 12/705,279

(22) Filed: Feb. 12, 2010

(30) Foreign Application Priority Data
Feb. 17, 2009 (KR) 10-2009-0013129

(51) Int. Cl. H01M 8/10; H01M 4/88

(52) U.S. Cl. 429/488; 252/182.1

(57) ABSTRACT

A fuel electrode material, a method of preparing the fuel electrode material and a solid oxide fuel cell including the fuel electrode material. The fuel electrode material includes a metal oxide bound to a surface of particles, the particles including nickel, copper or a combination thereof, wherein the metal oxide is an oxide of a metal element selected from the group consisting of cerium, titanium, silicon, aluminum, zirconium and a combination including at least one of the foregoing.

### CROSS-REFERENCE TO RELATED APPLICATIONS

This application claims priority to Korean Patent Application No. 10-2009-0013129, filed on Feb. 17, 2009, and all the benefits accruing therefrom under 35 U.S.C. §119, the content of which in its entirety is herein incorporated by reference.

### BACKGROUND

1. Field

One or more embodiments relate to a fuel electrode material, a method of preparing the fuel electrode material and a solid oxide fuel cell including the fuel electrode material. More particularly, one or more embodiments relate to a fuel electrode material with improved durability.

2. Description of the Related Art

Environmental and energy concerns related to the use and depletion of fossil fuels are drawing worldwide attention. To address these problems, great efforts have been devoted to research and commercialization of solid oxide fuel cells (“SOFCs”). SOFCs convert chemical energy, generated by a reaction between a fuel, such as hydrogen gas or a hydrocarbon, and air, into electrical energy.

An SOFC includes a membrane electrode assembly (“MEA”). The MEA includes an anode, a cathode and an electrolyte membrane disposed therebetween. Electrochemical reactions in SOFC include a cathode reaction, in which oxygen gas (O₂) supplied to the air electrode (cathode) is converted into oxygen ions (O²⁻), and an anode reaction, in which a fuel (H₂ or a hydrocarbon) supplied to the fuel electrode (anode) reacts with O²⁻, which migrates through the electrolyte membrane. These reactions are represented in Reaction Scheme 1 below:

Reaction Scheme 1 Cathode: ½O₂+2e⁻→O²⁻

Anode: H₂+O²⁻→H₂O+2e⁻.

Improvements in the fuel electrode (anode) of SOFCs are desirable in order to successfully commercialize SOFCs. A nickel oxide-yttria-stabilized zirconia (“NiO-YSZ”) composite material has been used in SOFCs as a fuel electrode material. In a NiO-YSZ fuel electrode, nickel oxide (NiO) is reduced to Ni and functions as an anode catalyst and as an electron transport material. Yttria-stabilized zirconia (“YSZ”) may include a material identical to the electrolyte and is considered responsible for the transport of ions.

A current challenging issue regarding SOFCs is to increase the durability of SOFCs. A cause of decreased durability is attributed to coarsening. Since SOFCs operate at high temperatures, nickel metal particles in SOFCs agglomerate, leading to fewer catalytically active sites and fewer three-phase interfaces.

It is therefore desirable to have a fuel cell electrode material with enhanced durability.

### SUMMARY

One or more embodiments include a fuel electrode material with improved durability.

One or more embodiments include a method of preparing the fuel electrode material.

One or more embodiments include a solid oxide fuel cell (“SOFC”) including the fuel electrode material.

Additional aspects are set forth in the description which follows.

To achieve the above and/or other aspects, one or more embodiments includes a fuel electrode material including a metal oxide bound to a surface of particles, the particles including nickel, copper or combination thereof, wherein the metal oxide is an oxide of a metal element selected from the group consisting of cerium, titanium, silicon, aluminum, zirconium and a combination including at least one of the foregoing.

To achieve the above and/or other aspects, one or more embodiments includes a method of preparing a fuel electrode material, the method including: dissolving a metal oxide precursor in a solvent to obtain a precursor solution; adding the precursor solution to an oxide including nickel oxide, a copper oxide or a combination thereof to obtain a mixed solution; evaporating the solvent from the mixed solution to obtain a solid component; sintering the solid component in air to obtain a sintered product; and reducing the sintered product.

To achieve the above and/or other aspects, one or more embodiments includes a solid oxide fuel cell including: a fuel electrode layer; an air electrode layer, and an electrolyte membrane disposed between the fuel electrode layer and the air electrode layer, wherein the fuel electrode layer includes a fuel electrode material, the fuel electrode material including a metal oxide bound to a surface of particles, the particles comprising nickel, copper or a combination thereof, wherein the metal oxide is an oxide of a metal element selected from the group consisting of cerium, titanium, silicon, aluminum, zirconium and a combination including at least one of the foregoing.

### BRIEF DESCRIPTION OF THE DRAWINGS

These and/or other aspects will become apparent and more readily appreciated from the following description of the embodiments, taken in conjunction with the accompanying drawings in which:

FIG. 1 is a schematic view of an exemplary embodiment of a fuel electrode material including a metal oxide that is bound to a surface of nickel particles, and an ion conducting oxide.

FIGS. 2A and 2B are scanning electron microscope (“SEM”) images of the fuel electrode material of Example 1, before sintering;

FIGS. 3A and 3B are SEM images of the fuel electrode material of Example 1, after sintering;

FIGS. 4A and 4B are SEM images of the fuel electrode material of Example 2, before sintering;

FIGS. 5A and 5B are SEM images of the fuel electrode material of Example 2, after sintering;

FIGS. 6A and 6B are SEM images of the fuel electrode material of Example 3, before sintering;

FIGS. 7A and 7B are SEM images of the fuel electrode material of Example 3, after sintering;

FIGS. 8A and 8B are SEM images of the fuel electrode material of Example 4, before sintering;

FIGS. 9A and 9B are SEM images of the fuel electrode material of Example 4, after sintering;

FIGS. 10A and 10B are SEM images of the fuel electrode material of Comparative Example 1, before sintering; and

FIGS. 11A and 11B are SEM images of the fuel electrode material of Comparative Example 1, after sintering.

### DETAILED DESCRIPTION

Reference will now be made in detail to embodiments, examples of which are illustrated in the accompanying drawings, wherein like reference numerals refer to like elements throughout. In this regard, the present embodiments may have different forms and should not be construed as being limited to the descriptions set forth herein. Accordingly, the embodiments are merely described below, by referring to the figures, to explain aspects of the present description.

It will be understood that when an element or layer is referred to as being “on” or “connected to” another element or layer, the element or layer can be directly on or connected to another element or layer or intervening elements or layers. In contrast, when an element is referred to as being “directly on” or “directly connected to” another element or layer, there are no intervening elements or layers present. As used herein, the term “and/or” includes any and all combinations of one or more of the associated listed items.

It will be understood that, although the terms first, second, third, etc., can be used herein to describe various elements, components, regions, layers and/or sections, these elements, components, regions, layers and/or sections should not be limited by these terms. These terms are only used to distinguish one element, component, region, layer or section from another region, layer or section. Thus, a first element, component, region, layer or section discussed below could be termed a second element, component, region, layer or section without departing from the teachings of the exemplary embodiments of the invention.

Spatially relative terms, such as “below,” “lower,” “upper” and the like, can be used herein for ease of description to describe one element or feature's relationship to another element(s) or feature(s) as illustrated in the figures. It will be understood that the spatially relative terms are intended to encompass different orientations in use or operation in addition to the orientation depicted in the figures. Thus, the exemplary term “below” can encompass both an orientation of above and below.

As used herein, the singular forms “a,” “an,” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

Embodiments of the invention are described herein with reference to schematic illustrations of idealized embodiments (and intermediate structures) of the invention. As such, variations from the shapes of the illustrations as a result, for example, of manufacturing techniques and/or tolerances, are to be expected. Thus, embodiments of the invention should not be construed as limited to the particular shapes of regions illustrated herein but are to include deviations in shapes that result, for example, from manufacturing. Thus, the regions illustrated in the figures are schematic in nature and their shapes are not intended to illustrate an actual shape and are not intended to limit the scope of the invention.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

All methods described herein can be performed in a suitable order unless otherwise indicated herein or otherwise clearly contradicted by context. The use of any and all examples, or exemplary language (e.g., “such as”), is intended merely to better illustrate the invention and does not pose a limitation on the scope of the invention unless otherwise claimed. No language in the specification should be construed as indicating any non-claimed element as essential to the practice of the invention as used herein.

According to one or more embodiments, a metal oxide that is stable at high temperatures is bound to a surface of particles and can be used as a fuel electrode material, and thus the fuel electrode has strong resistance to coarsening or sintering. In an embodiment, the particles comprise nickel, copper, or the like or a combination thereof. In another embodiment, the particles consist essentially of nickel, copper, or the like or a combination thereof. In yet another embodiment, the particles consist of nickel, copper or a combination thereof.

The metal oxide chemically binds to portions of the surface of the particles, and may be used as a fuel electrode material, and thus provides a fuel electrode material with a strong resistance to coarsening or sintering. If the fuel electrode material has a strong resistance to coarsening or sintering, the durability of a solid oxide fuel cell (“SOFC”) including the fuel electrode material may be improved. As a result, an SOFC including the fuel electrode material may have improved lifespan, durability and electrical characteristics.

Examples of metal oxides that are stable at high temperatures, may include, but are not limited to, oxides of a metal element selected from the group consisting of cerium, titanium, silicon, aluminum, zirconium, and the like and a combination comprising at least one of the foregoing. In an embodiment, the metal oxide may consist essentially of an oxide of a metal element selected from the group consisting of cerium, titanium, silicon, aluminum, zirconium, and the like and a combination thereof.

In another embodiment, the metal oxide may consist of an oxide of a metal element selected from the group consisting of cerium, titanium, silicon, aluminum, zirconium and a combination thereof. For example, such metal oxides may include SiO₂, TiO₂, CeO, Al₂O₃, ZrO₂, or the like or a combination comprising at least one of the foregoing. In another embodiment, exemplary metal oxides consist essentially of SiO₂, TiO₂, CeO, Al₂O₃, ZrO₂, or the like or a combination comprising at least one of the foregoing. In yet another embodiment, exemplary metal oxides consist of SiO₂, TiO₂, CeO, Al₂O₃, ZrO₂ or a combination comprising at least one of the foregoing.

The amount of the metal element to be included in the metal oxide may be in a range of about 0.01 weight percent (wt %) to about 5 wt %, specifically in a range of about 0.1 wt % to about 1 wt %, more specifically about 0.5 wt % based on the total weight of the fuel electrode material. If the amount of the metal element is within the above range, the resistance to coarsening or sintering of the fuel electrode material may be sufficient and the electrical characteristics, lifetime and durability of the fuel electrode material may be improved.

The metal oxide can be partially chemically bound to the surface of the particles. The chemical bonding may be covalent bonding, ionic bonding, Van der Waals bonding, or the like or a combination thereof.

The metal oxide may be in the form of fine particles. For example, the metal oxide may have an average particle diameter of equal to or less than about 100 nanometers (nm), or the average particle diameter may be in a range of about 1 nm to about 90 nm, specifically in a range of about 2 nm to about 50 nm, more specifically in a range of about 5 nm to about 25 nm. If the average particle diameter of the metal oxide is within the above range, the fuel electrode material may have sufficient durability, including resistance to coarsening or sintering. In another embodiment, the average particle diameter may be equal to or greater than 100 nm.

Without being bound by theory, it is believed that because the metal oxide binds to the surface of the particles, a fuel electrode material including the metal oxide can have desirable durability and substantially resist or completely avoid coarsening or sintering. Due to the resistance of the fuel electrode material against coarsening or sintering, a specific surface area of the fuel electrode material can be maintained after sintering, resulting in one or more of improved lifespan, durability and electrical characteristics of the fuel electrode material.

The fuel electrode material including nickel or copper particles with the metal oxide that is stable at high temperatures bound on the surface of the particles may have a specific surface area, for example, a Brunauer-Emmett-Teller (“BET”) specific surface area in a range of about 0.05 square meters per gram (m²/g) to about 1 m²/g, specifically in a range of about 0.1 m²/g to about 0.5 m²/g, more specifically about 0.3 m²/g . In an embodiment, the fuel electrode material may have a specific surface area in a range of about 0.05 m²/g to about 1 m²/g, specifically in a range of about 0.1 m²/g to about 0.5 m²/g, more specifically about 0.3 m²/g after sintering or high-speed sintering. In an embodiment, the sintering may be performed at a temperature of about 500° C. to about 1500° C., specifically about 700° C. to about 1100° C., more specifically about 900° C. in an atmosphere comprising about 1 vol % and about 100 vol % hydrogen, specifically about 5 volume percent (“vol %”) hydrogen and about 95 vol % nitrogen, for a time of about 1 hour and about 100 hours, specifically about 2 hours and about 50 hours, more specifically about 12 hours.

In addition, the fuel electrode material may further include an ion conducting oxide to further improve the electrical characteristics. The amount of the ion conducting oxide may be in a range of about 20 wt % to about 50 wt %, specifically in a range of about 25 to about 40 wt %, more specifically about 30 wt %, each based on the total weight of the fuel electrode material. Use of an amount of the ion conducting oxide within the above range may provide sufficient oxide ion conduction in the fuel electrode to facilitate anode reactions.

The ion conducting oxide may be at least one material selected from the group consisting of yttria-stabilized zirconia (“YSZ”), scandia-stabilized zirconia (“SSZ”), samaria-doped ceria (“SDC”), gadolinia-doped ceria (“GDC”) and the like. In another embodiment, the ion conducting oxide may consist essentially of an ion conducting oxide selected from the group consisting of YSZ, SSZ, SDC, GDC and the like and a combination thereof. In yet another embodiment, the ion conducting oxide may consist of an ion conducting oxide selected from the group consisting of YSZ, SSZ, SDC, GDC and a combination thereof.

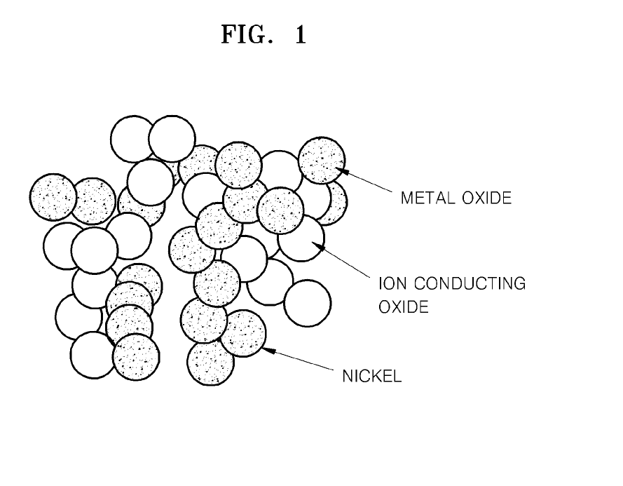

FIG. 1 is a schematic view of an exemplary embodiment of a fuel electrode material including a metal oxide that is bound to a surface of nickel particles, and an ion conducting oxide.

In addition, the fuel electrode material may further include an electron conducting material. The amount of the electron conducting material may be in a range of about 10 wt % to about 50 wt %, specifically in a range of about 20 wt % to about 40 wt %, more specifically about 30 wt % based on the total weight of the fuel electrode material. If the amount of the electron conducting material is within the above range, the fuel electrode may have sufficient electrical conductivity and may have decreased loss in conductivity.

The electron conducting oxide may be at least one material selected from the group consisting of perovskite oxides, for example, LaMnO₃, LaCoO₃, (La,Sr)MnO₃, (La,Ca)MnO₃, (La,Sr)CoO₃, (La,Ca)CoO₃ and the like. In another embodiment, the electron conducting oxide may consist essentially of a material selected from the group consisting of LaMnO₃, LaCoO₃, (La,Sr)MnO₃, (La,Ca)MnO₃, (La,Sr)CoO₃, (La,Ca)CoO₃, and the like and a combination thereof. In yet another embodiment, the electron conducting oxide may consist of a material selected from the group consisting of LaMnO₃, LaCoO₃, (La,Sr)MnO₃, (La,Ca)MnO₃, (La,Sr)CoO₃, (La,Ca)CoO₃ and a combination thereof.

The fuel electrode material described above may be prepared in the following manner.

Initially, a metal oxide precursor is dissolved in a solvent to prepare a precursor solution. The precursor solution is added to an oxide, such as a nickel oxide or a copper oxide, to obtain a mixed solution. The solvent is evaporated, optionally while stirring the mixed solution, until only a solid component remains. The solid component is sintered in air. The sintered product is reduced so that the metal oxide binds to the surface of the resulting particles, which can be nickel or copper particles, thereby resulting in a fuel electrode material.

The solvent may be, but is not be limited to, a solvent that can substantially or partially dissolve the metal oxide precursor, including lower alcohols having five or fewer carbon atoms, such as methanol, ethanol, 1-propanol, 2-propanol, butanol or the like; acidic solutions, such as a nitric acid solution, a hydrochloric acid solution, a sulfuric acid solution or the like; water; an organic solvent, such as toluene, benzene, acetone, diethyl ether, and ethylene glycol or the like; or combinations thereof, so long as the combination results in a chemically stable solvent.

The metal oxide precursor may include, for example, silicic acid, titanic acid, silicon nitrate, titanium nitrate, aluminum nitrate, cerium nitrate, silicon tetrachloride, titanium tetrachloride, aluminum chloride, cerium chloride, silicon sulfate, titanium sulfate, aluminum sulfate, cerium sulfate, silicon acetate, titanium acetate, aluminum acetate, cerium acetate, or the like or a combination thereof. In another embodiment, the metal oxide precursor may consist essentially of silicic acid, titanic acid, silicon nitrate, titanium nitrate, aluminum nitrate, cerium nitrate, silicon tetrachloride, titanium tetrachloride, aluminum chloride, cerium chloride, silicon sulfate, titanium sulfate, aluminum sulfate, cerium sulfate, silicon acetate, titanium acetate, aluminum acetate, cerium acetate, or the like or a combination thereof. In yet another embodiment, the metal oxide precursor may consist of silicic acid, titanic acid, silicon nitrate, titanium nitrate, aluminum nitrate, cerium nitrate, silicon tetrachloride, titanium tetrachloride, aluminum chloride, cerium chloride, silicon sulfate, titanium sulfate, aluminum sulfate, cerium sulfate, silicon acetate, titanium acetate, aluminum acetate, cerium acetate or a combination thereof.

The amount of the metal oxide precursor may be in a range of about 0.1 parts by weight to about 100 parts by weight, specifically in a range of about 1 part by weight to about 75 parts by weight, more specifically in a range of about 5 parts by weight to about 50 parts by weight, based on 100 parts by weight of the solvent. For example, the amount of the metal oxide precursor may be varied such that the final product contains about 0.01 wt % to about 5 wt %, specifically about 0.1 wt % to about 1 wt %, more specifically about 0.5 wt % of the metal element based on the weight of the final product.

The precursor solution, which is obtained by dissolving the metal oxide precursor in the solvent, may be added all at once or dropwise to the oxide, which can be nickel oxide or copper oxide, to prepare the mixed solution.

Next, the mixed solution is subjected to a drying process to evaporate and remove the solvent and to provide a solid component. In the drying process, the mixed solvent may be stirred to suppress agglomeration of particles, for example, by mechanical stirring, magnetic stirring, ultrasonic stirring, or the like or a combination comprising at least one of the foregoing.

Once the solid component is obtained through the drying process, the solid component is sintered at a temperature of about 300° C. to about 1000° C., specifically about 400° C. to about 700° C., more specifically about 500° C. to about 600° C. in air for a time of about 0.5 hours to about 10 hours, specifically about 1 hour to about 5 hours, more specifically about 2 hours.

The sintered product resulting from the sintering process is reduced to an oxide. The reduction process may be performed under a reducing atmosphere, for example, in an atmosphere comprising hydrogen. The reduction process may be performed at a temperature of about 300° C. to about 1000° C., specifically about 400° C. to about 700° C., more specifically about 500° C. to about 600° C. for a time of about 0.5 hours to about 10 hours, specifically about 1 hour to about 5 hours, more specifically about 2 hours.

Through the processes described above, the metal oxide that is stable at high temperatures can be bound to the surface of the particles, which can be nickel particles or copper particles.

The fuel electrode material may further comprise an ion conducting oxide or an electron conducting material.

The fuel electrode material prepared as described above may be used in various industrial fields, for example, in an SOFC.

One or more embodiments provide an SOFC including a fuel electrode layer, an air electrode layer and an electrolyte membrane disposed between the fuel electrode layer and the air electrode layer, wherein the fuel electrode layer may include the fuel electrode material prepared according to the method described above.

The electrolyte membrane may comprise at least one composite metal oxide in particle form selected from the group consisting of zirconium oxide, cerium oxide and lanthanum oxide, which are known as electrolyte materials for SOFCs. The electrolyte membrane material in particle form may include, for example, YSZ, SSZ, SDC, GDC and combinations thereof. The electrolyte membrane may have a thickness of about 10 nm to about 100 micrometers (μm), specifically about 1 μm to about 90 μm, more specifically about 10 μm. Alternatively, the electrolyte membrane may have a thickness of about 100 nm to about 50 μm.

The air electrode layer may comprise a metal oxide in particle form having a perovskite crystalline structure. The air electrode layer may include, for example, (Sm,Sr)CoO₃, (La,Sr)MnO₃, (La,Sr)CoO₃, (La,Sr)(Fe,Co)O₃, (La,Sr)(Fe,Co,Ni)O₃, or the like or a combination comprising at least one of the foregoing. In addition, the air electrode layer may comprise a precious metal, such as platinum (Pt), ruthenium (Ru) or palladium (Pd).

The fuel electrode material prepared using the method described above may be used as a material for the fuel electrode layer. In another embodiment, the fuel electrode may further comprise the particulate metal oxide used in the electrolyte membrane, for example YSZ, SSZ, SDC, GDC and combinations thereof.

An embodiment will now be described in greater detail with reference to the following examples. These examples are for illustrative purposes only and are not intended to limit the scope of the inventive concept.

### Example 1

In this example, 1.4 grams (g) of cerium nitrate was dissolved in 20 g of ethanol to obtain a solution. The solution was added dropwise to 12 g of nickel oxide, and ultrasound having a frequency of 10 kHz or greater was applied to the mixture to evaporate the ethanol and obtain a solid component. Subsequently, the solid component was sintered at 500° C. in air for 4 hours and then reduced at 500° C. in a hydrogen atmosphere to yield 9 g of nickel particles with cerium oxide partially bound to the surface of the nickel particles. Herein, the amount of cerium was adjusted to be 2 wt % of the resulting product.

The resulting product was subjected to a sintering process.

The sintering process was performed at 900° C. in an atmosphere of 5 vol % hydrogen and 95 vol % nitrogen for 12 hours.

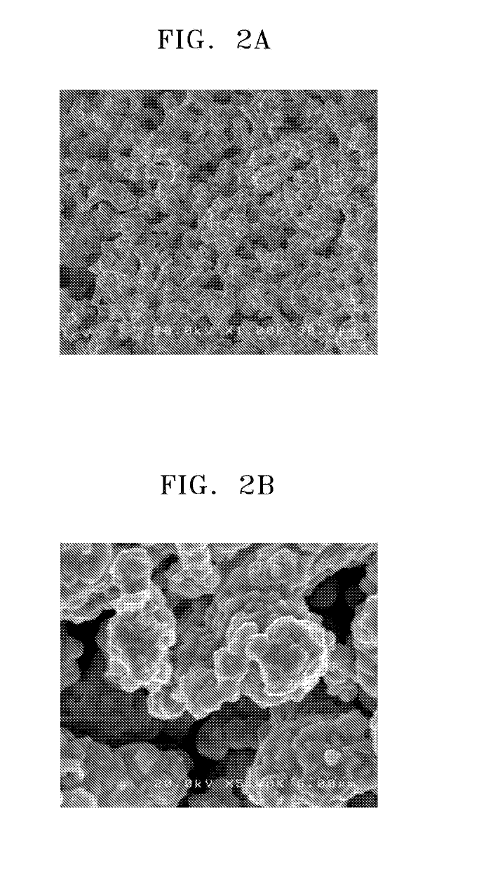

Scanning electron microscope (“SEM”) images of the resulting product before sintering are shown in FIGS. 2A and 2B. FIG. 2B is a partially magnified view of FIG. 2A.

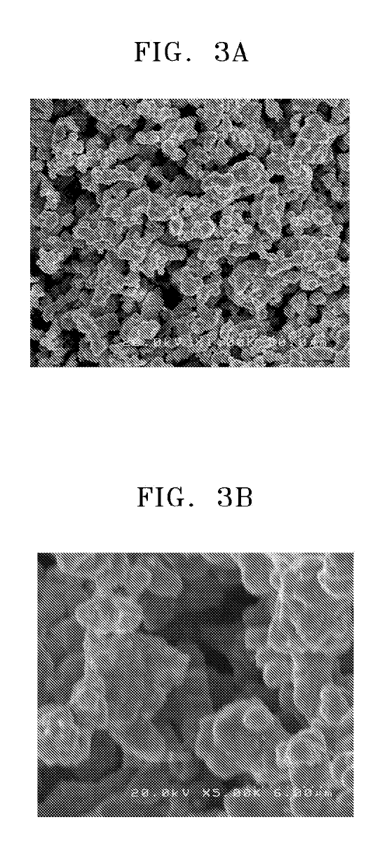

SEM images of the resulting product after sintering are shown in FIGS. 3A and 3B. FIG. 3B is a partially magnified view of FIG. 3A.

As can be seen from FIGS. 2A, 2B, 3A and 3B, the resulting product generally maintains the original morphological structure after sintering.

A BET specific surface area was measured on the resulting product after sintering. As a result, the resulting product after sintering had a BET specific surface area of 0.273 m²/g. This relatively large BET specific surface area indicates that the resulting product has a strong resistance against sintering.

### Example 2

In this example, 9 g of nickel particles with cerium oxide (CeO) bound to the surface was prepared in the same manner as in Example 1, except that water instead of ethanol was used as the solvent.

The resulting product was subjected to a sintering process.

The sintering process was performed at 900° C. in an atmosphere of 5 vol % hydrogen and 95 vol % nitrogen for 12 hours.

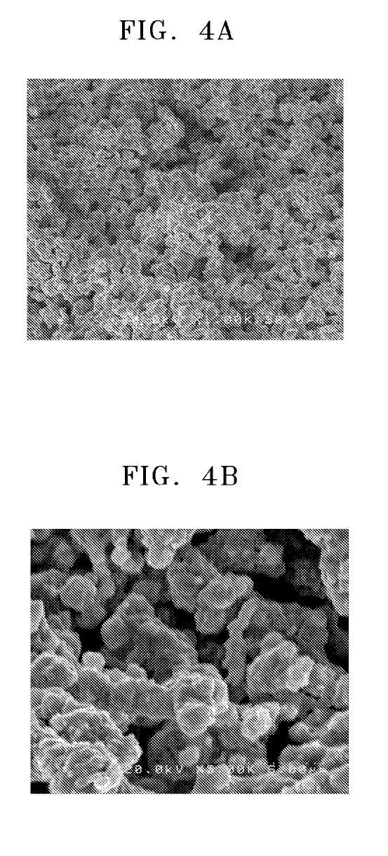

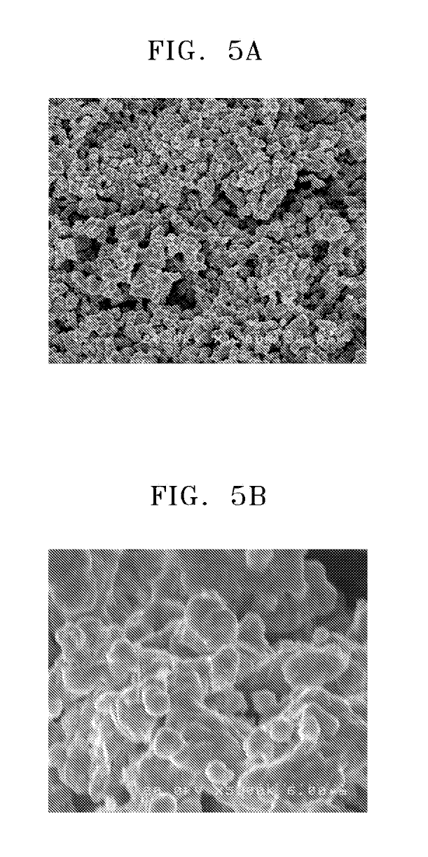

SEM images of the resulting product before sintering are shown in FIGS. 4A and 4B. FIG. 4B is a partially magnified view of FIG. 4A. SEM images of the resulting product after sintering are shown in FIGS. 5A and 5B. FIG. 5B is a partially magnified view of FIG. 5A.

As can be seen from FIGS. 4A, 4B, 5A and 5B, the resulting product generally maintains the original morphological structure after sintering.

### Example 3

Twelve grams of the nickel oxide was impregnated with 2.45 g of a solution of 20 wt % of titanium chloride dissolved in a 3 wt % hydrochloric acid solution while an ultrasonic wave of 40 kHz was applied to the nickel oxide. The resulting product was subjected to the same processes as in Example 1 to yield 9 g of nickel particles with the titanium oxide bound to the surface. Herein the amount of titanium was adjusted to be 2 wt % of the resulting product.

The resulting product was subjected to a sintering process.

The sintering process was performed at 900° C. in an atmosphere of 5 vol % hydrogen and 95 vol % nitrogen for 12 hours.

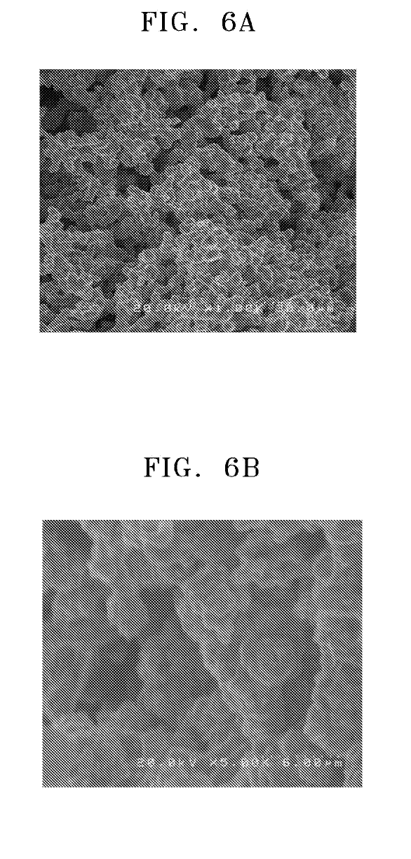

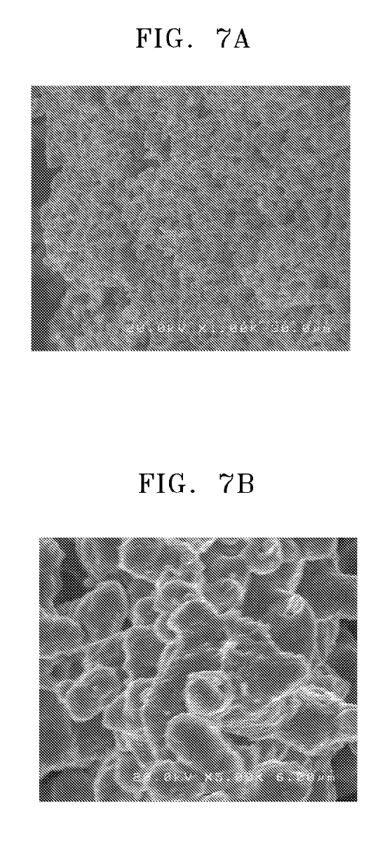

SEM images of the resulting product before sintering are shown in FIGS. 6A and 6B. FIG. 6B is a partially magnified view of FIG. 6A. SEM images of the resulting product after sintering are shown in FIGS. 7A and 7B. FIG. 7B is a partially magnified view of FIG. 7A.

As can be seen from FIGS. 6A, 6B, 7A and 7B, the resulting product generally maintains the original morphological structure after sintering.

A BET specific surface area was measured on the resulting product after sintering. The resulting product after sintering had a BET specific surface area of 0.1180 m²/g. This relatively large BET specific surface area indicates that the resulting product has a strong resistance against sintering.

### Example 4

A colloidal solution of 0.425 g of silicic acid dispersed in 20 g of ethanol was prepared as a precursor solution. The resulting product was subjected to the same processes as in Example 1 to yield 9 g of nickel particles with the silicon oxide bound to the surface. Herein the silicon was adjusted to be 2 wt % of the resulting product.

The resulting product was subjected to a sintering process.

The sintering process was performed at 900° C. in an atmosphere of 5 vol % hydrogen and 95 vol % nitrogen for 12 hours.

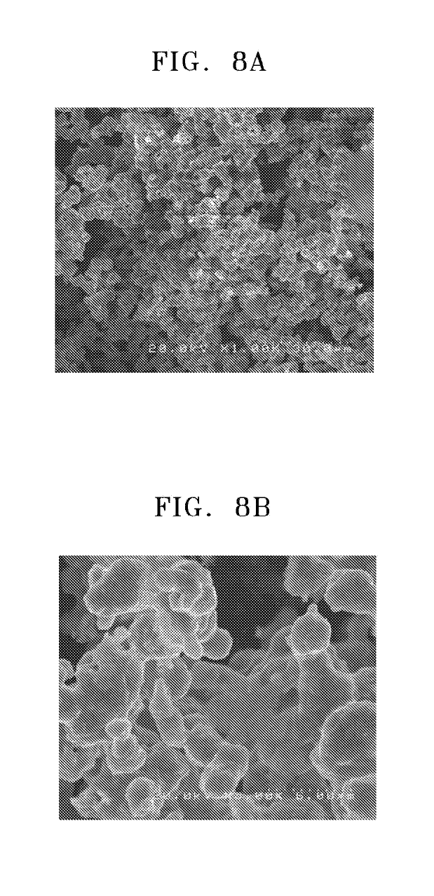

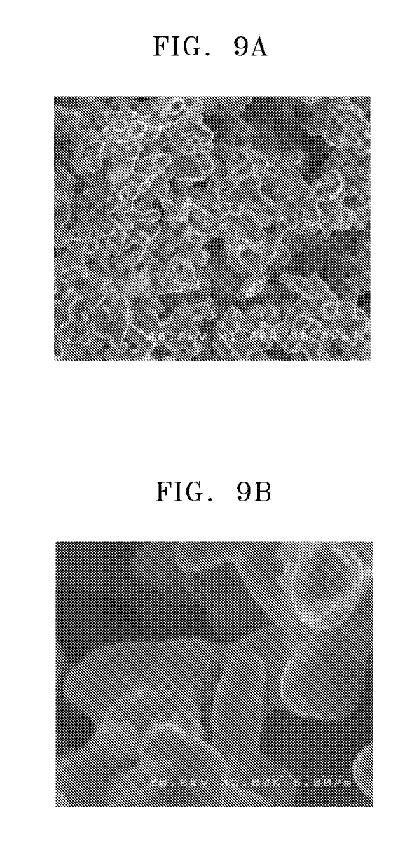

SEM images of the resulting product before sintering are shown in FIGS. 8A and 8B. FIG. 8B is a partially magnified view of FIG. 8A. SEM images of the resulting product after sintering are shown in FIGS. 9A and 9B. FIG. 9B is a partially magnified view of FIG. 9A.

As can be seen from FIGS. 8A, 8B, 9A and 9B, the resulting product generally maintains the original structure after sintering.

### Comparative Example 1

Twelve grams of nickel oxide were reduced at 500° C. in a hydrogen condition to obtain nickel.

The resulting product was subjected to a sintering process.

The sintering process was performed at 900° C. in an atmosphere of 5 vol % hydrogen and 95 vol % nitrogen for 12 hours.

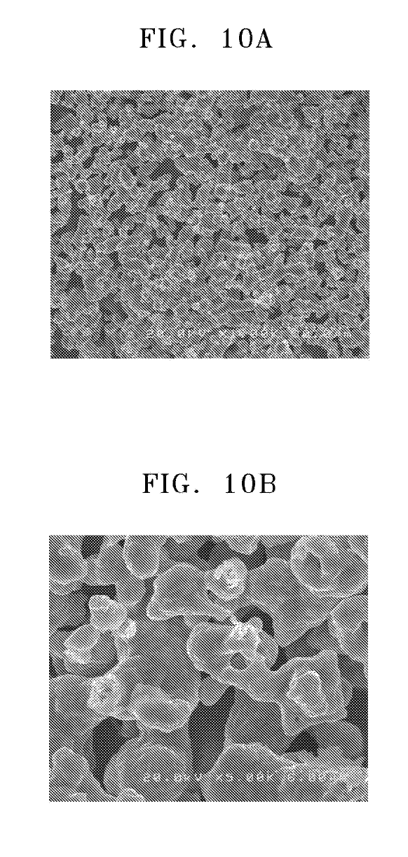

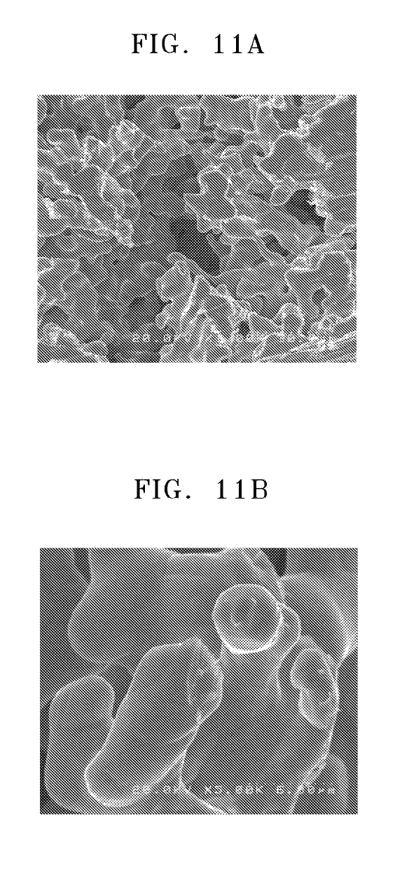

SEM images of the resulting product before sintering are shown in FIGS. 10A and 10B. FIG. 10B is a partially magnified view of FIG. 10A. SEM images of the resulting product after sintering are shown in FIGS. 11A and 11B. FIG. 11B is a partially magnified view of FIG. 11A.

As can be seen from FIGS. 10A, 10B, 11A and 11B, the resulting product of Comparative Example 1 fails to maintain the original structure after sintering and undergoes agglomeration.

A BET specific surface area was measured on the resulting product of Comparative Example 1 after sintering. The resulting product of Comparative Example 1 after sintering had a BET specific surface area of 0.021 m²/g. This relatively small BET specific surface area indicates that the resulting product has a weak resistance against sintering.

As described above, for the fuel electrode materials prepared in Examples 1 through 4, by binding metal oxides, which are stable at high temperatures, to the surface of nickel particles, the original morphological structure of the fuel electrode material can be maintained before and after sintering, and only a small change in the specific surface is observed, indicating improvement in resistance to coarsening or sintering. In addition, for the fuel electrode material prepared in Comparative Example 1, which does not include a metal oxide, agglomeration occurs after sintering, and the specific surface area decreases to about one fifth or less compared to those containing metal oxides.

As described above, according to the one or more of the above embodiments, a fuel electrode material with improved resistance to high-temperature sintering is prepared by binding a fine particle-sized metal oxide that is stable at high temperatures to the surface of particles, such as nickel or copper particles, which are fuel electrode materials for commercial SOFCs. The fuel electrode material exhibits improved lifetime characteristics when used in various industrial products, such as SOFCs, and thus has high applicability.

It should be understood that the exemplary embodiments described therein should be considered in a descriptive sense only and not for purposes of limitation. Descriptions of features or aspects within each embodiment should typically be considered as available for other similar features or aspects in other embodiments.

What is claimed is:

1. A fuel electrode material, comprising:
a metal oxide bound to a surface of particles, the particles comprising nickel, copper or a combination thereof, wherein the metal oxide is an oxide of a metal element selected from the group consisting of cerium, titanium, silicon, aluminum, zirconium and a combination thereof.

2. The fuel electrode material of claim 1, wherein the metal oxide is further selected from the group consisting of SiO₂, TiO₂, CeO, Al₂O₃, ZrO₂ and a combination thereof.

3. The fuel electrode material of claim 1, wherein the amount of the metal element is in a range of about 0.01 weight percent to about 5 weight percent based on the total weight of the fuel electrode material.

4. The fuel electrode material of claim 1, wherein the metal oxide is chemically bound to the surface of the particles.

5. The fuel electrode material of claim 1, wherein the metal oxide has an average particle diameter of equal to or less than about 100 nanometers.

6. The fuel electrode material of claim 1, having a specific surface area of about 0.05 square meters per gram to about 1 square meter per gram after sintering at about 900° C. in gas comprising about 5 volume percent hydrogen and about 95 volume percent nitrogen for about 12 hours.

7. The fuel electrode material of claim 1, further comprising an ion conducting oxide in an amount of about 20 weight percent to about 50 weight percent based on the total weight of the fuel electrode material.

8. The fuel electrode material of claim 7, wherein the ion conducting oxide is selected from the group consisting of yttria-stabilized zirconia, scandia-stabilized zirconia, samaria-doped ceria, gadolinia-doped ceria and a combination comprising at least one of the foregoing.

9. The fuel electrode material of claim 1, further comprising an electron conducting oxide in an amount of about 10 weight percent to about 50 weight percent, based on the total weight of the fuel electrode material.

10. The fuel electrode material of claim 9, wherein the electron conducting material is selected from the group consisting of LaMnO₃, LaCoO₃, (La,Sr)MnO₃, (La,Ca)MnO₃, (La,Sr)CoO₃, (La,Ca)CoO₃ and a combination comprising at least one of the foregoing.

11. A method of preparing a fuel electrode material, the method comprising:
dissolving a metal oxide precursor in a solvent to obtain a precursor solution;
adding the precursor solution to an oxide comprising nickel oxide, copper oxide or a combination thereof to obtain a mixed solution;
evaporating the solvent from the mixed solution to obtain a solid component;
sintering the solid component in air to obtain a sintered product; and
reducing the sintered product.

12. The method of claim 11, wherein the metal oxide precursor is at least one selected from the group consisting of silicic acid, titanic acid, silicon nitrate, titanium nitrate, aluminum nitrate, cerium nitrate, silicon tetrachloride, titanium tetrachloride, aluminum chloride, cerium chloride, silicon sulfate, titanium sulfate, aluminum sulfate, cerium sulfate, silicon acetate, titanium acetate, aluminum acetate and cerium acetate.

13. The method of claim 11, wherein the amount of the metal oxide precursor is in a range of about 0.1 to about 100 parts by weight based on 100 parts by weight of the solvent.

14. A solid oxide fuel cell comprising:
a fuel electrode layer;
an air electrode layer; and
an electrolyte membrane disposed between the fuel electrode layer and the air electrode layer,
wherein the fuel electrode layer includes a fuel electrode material, the fuel electrode material comprising a metal oxide bound to a surface of particles, the particles comprising nickel, copper or a combination thereof, wherein the metal oxide is an oxide of a metal element selected from the group consisting of cerium, titanium, silicon, aluminum, zirconium and a combination comprising at least one of the foregoing.
